(19) United States
(12) Patent Application Publication
(10) Pub. No.: US 2016/0110112 A1
(43) Pub. Date: Apr. 21, 2016

(54) DATA WRITING METHOD, MEMOEY CONTROL CIRCUIT UNIT AND MEMORY STORAGE APPARATUS

(71) Applicant: PHISON ELECTRONICS CORP., Miaoli (TW)

(72) Inventor: Chih-Kang Yeh, Kinmen County (TW)

(21) Appl. No.: 14/564,113

(22) Filed: Dec. 9, 2014

(30) Foreign Application Priority Data
Oct. 20, 2014 (TW) 103136136

(51) Int. Cl. G06F 3/06

(52) U.S. Cl. CPC G06F 3/0608; G06F 3/0679; G06F 3/0655; G06F 3/0641; G06F 3/0659; G06F 2206/1014

(57) ABSTRACT

A data writing method for a rewritable non-volatile memory module is provided. The method includes: if data belongs to a first pattern, using a first compression/decompression circuit to compress the data to generate compressed data and writing the compressed data into the rewritable non-volatile memory module; and if data belongs to a second pattern, using a second compression/decompression circuit to compress the data to generate another compressed data and writing the another compressed data into the rewritable non-volatile memory module, wherein the compression speed of the first compression/decompression circuit is higher than that of the second compression/decompression circuit, and the compression rate of the first compression/decompression circuit is lower than that of the second compression/decompression circuit.

### CROSS-REFERENCE TO RELATED APPLICATION

This application claims the priority benefit of Taiwan application serial no. 103136136, filed on Oct. 20, 2014. The entirety of the above-mentioned patent application is hereby incorporated by reference herein and made a part of this specification.

### BACKGROUND

1. Technology Field

The present invention is directed to a data writing method and more particularly, to a data writing method for a rewritable non-volatile memory module, a memory control circuit unit and a memory storage apparatus using the method.

2. Description of Related Art

Along with the widespread of digital cameras, cell phones, and MP3 players in recently years, the consumers' demand to storage media has increased drastically. Because a rewritable non-volatile memory is capable of providing features such as data non-volatility, low power consumption, small volume, and non-mechanical structure, high reading and writing speed, the rewritable non-volatile memory has become the most adaptable memory applied in a portable electronic product, e.g., a notebook computer. A solid state drive (SSD) is a storage apparatus which utilizes a flash memory as its storage medium. Therefore, the flash memory industry has become a very popular part of the electronic industry in recent years.

In recent years, control circuits of flash memory storage apparatuses use compression circuits to compress data to be written and then write the compressed data into the flash memories, so as to utilize the storage spaces more effectively or to improve data error correcting capability. For example, a physical page includes a data bit area storing user data and a redundant bit area storing management information (e.g., an error correcting code), and if the user data is capable of being compressed into data with a smaller size, unused spaces in the data bit area can be then used to store more error correcting codes or filled with constant bit values, so as to reinforce the data error correcting capability. However, in order to avoid delay occurring to the time for executing a write command, a compression circuit configured in a flash memory storage apparatus may use a compression algorithm mechanism with a higher computation speed. Nevertheless, such compression circuit with the higher computation speed turns to have a lower compression efficiency in most cases. Therefore, how to satisfy a bandwidth of a data bus without delaying the time for executing the write command, as well as achieve a better compression efficiency is a goal for technicians of this field to make effort to.

Nothing herein should be construed as an admission of knowledge in the prior art of any portion of the invention. Furthermore, citation or identification of any document in this application is not an admission that such document is available as prior art to the invention, or that any reference forms a part of the common general knowledge in the art.

### SUMMARY

Accordingly, the present invention is directed to a data writing method, a memory control circuit unit and a memory storage apparatus capable of satisfying the bandwidth of a data bus without delaying the time for executing a write command, as well as achieving an optimal compression rate.

According to an exemplary embodiment of the present invention, a data writing method for a rewritable non-volatile memory module is provided. The rewritable non-volatile memory module has a plurality of physical erasing units, and each of the physical erasing units has a plurality of physical programming units. The data writing method includes: identifying whether data belongs to a first pattern or a second pattern; if the data belongs to the first pattern, using a first compression/decompression circuit to compress the data to generate compressed data and writing the compressed data into the physical programming units; and if the data belongs to the second pattern, using a second compression/decompression circuit to compress the data to generate another compressed data and writing the another compressed data into the physical programming units, wherein a compression speed of the first compression/decompression circuit is higher than a compression speed of the second compression/decompression circuit, and a data compression rate of the first compression/decompression circuit is lower than a data compression rate of the second compression/decompression circuit.

According to an exemplary embodiment of the present invention, a memory control circuit unit for controlling a rewritable non-volatile memory module is provided. The memory control circuit unit includes a host interface, a memory interface, a memory management circuit, a first compression/decompression circuit and a second compression/decompression circuit. The host interface is configured to be coupled to a host system. The memory interface is configured to be coupled to the rewritable non-volatile memory module. The rewritable non-volatile memory module has a plurality of physical erasing units, and each of the physical erasing units has a plurality of physical programming units. The memory management circuit is coupled to the host interface and the memory interface. The first compression/decompression circuit and the second compression/decompression circuit are coupled to the memory management circuit, wherein a compression speed of the first compression/decompression circuit is higher than a compression speed of the second compression/decompression circuit, and a data compression rate of the first compression/decompression circuit is lower than a data compression rate of the second compression/decompression circuit. Herein, the memory management circuit identifies whether data belongs to a first pattern or a second pattern. If the data belongs to the first pattern, the first compression/decompression circuit compresses the data to generate compressed data, and the memory management circuit issues a command sequence to write the compressed data into the physical programming units. If the data belongs to the second pattern, the second compression/decompression circuit compresses the data to generate another compressed data, and the memory management circuit issues a command sequence to write the another compressed data into the physical programming units.

According to an exemplary embodiment of the present invention, a memory storage apparatus including a connection interface unit, a rewritable non-volatile memory module and a memory control circuit unit is provided. The connection interface unit is configured to be coupled to a host system. The rewritable non-volatile memory module has a plurality of physical erasing units, and each of the physical erasing units includes a plurality of physical programming units. The memory control circuit unit is coupled to the connection interface unit and the rewritable non-volatile memory module. The memory control circuit unit identifies whether data belongs to a first pattern or a second pattern. If the data belongs to the first pattern, the memory control circuit unit uses a first compression/decompression circuit to compress the data to generate compressed data and writes the compressed data into the physical programming units. If the data belongs to the second pattern, the memory control circuit unit uses a second compression/decompression circuit to compress the data to generate compressed another compressed data and writes the another compressed data into the physical programming units. Herein, a compression speed of the first compression/decompression circuit is higher than a compression speed of the second compression/decompression circuit, and a data compression rate of the first compression/decompression circuit is lower than a data compression rate of the second compression/decompression circuit.

In light of the forgoing, the data writing method, the memory control circuit unit and the memory storage apparatus provided by the exemplary embodiments of the present invention can select different compression/decompression circuits for compression according to different patterns of the data to be written into the physical programming units, so as to meet the requirements of high speed and high compression rate.

It should be understood, however, that this Summary may not contain all of the aspects and embodiments of the invention, is not meant to be limiting or restrictive in any manner, and that the invention as disclosed herein is and will be understood by those of ordinary skill in the art to encompass obvious improvements and modifications thereto.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart illustrating a data writing method according to an exemplary embodiment.

FIG. 2 illustrates a host system and a memory storage apparatus according to an exemplary embodiment.

FIG. 3A is a schematic diagram illustrating a computer, an input/output (I/O) apparatus, and a memory storage apparatus according to an exemplary embodiment.

FIG. 3B is a schematic diagram illustrating a host system and a memory storage apparatus according to an exemplary embodiment.

FIG. 4 is a schematic block diagram illustrating a memory storage apparatus according to a first exemplary embodiment.

FIG. 5 is a schematic block diagram illustrating a memory control circuit unit according to the first exemplary embodiment.

FIG. 6 and FIG. 7 are schematic diagrams illustrating examples of managing the physical blocks according to the first exemplary embodiment.

FIG. 8 to FIG. 20 illustrate examples of writing data according to the first exemplary embodiment.

FIG. 21 and FIG. 22 illustrate simplified examples of performing a merge procedure on the valid data to complete the subsequent write commands according to the first exemplary embodiment.

FIG. 23 and FIG. 24 are flowcharts illustrating the data writing method according to the first exemplary embodiment.

FIG. 25 is a flowchart illustrating a data writing method according to the second exemplary embodiment.

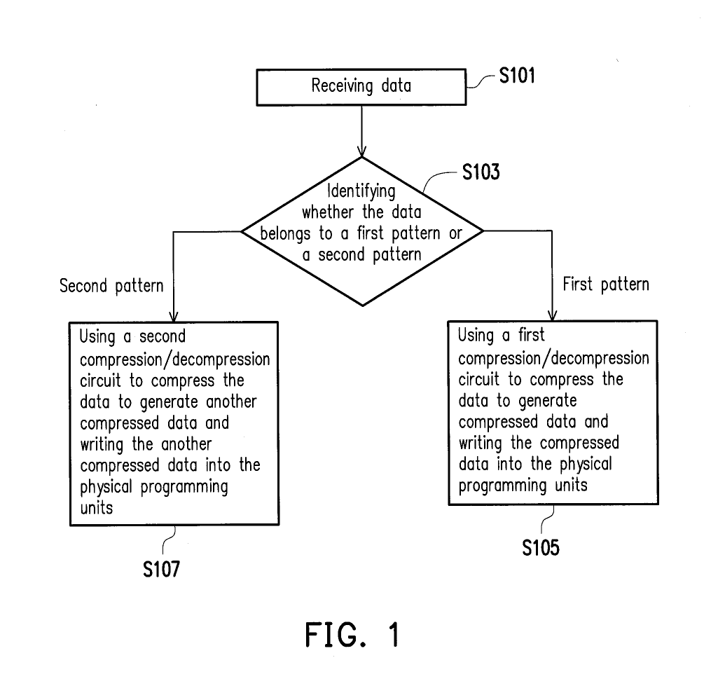

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Embodiments of the invention may comprise any one or more of the novel features described herein, including in the Detailed Description, and/or shown in the drawings. As used herein, “at least one”, “one or more”, and “and/or” are open-ended expressions that are both conjunctive and disjunctive in operation. For example, each of the expressions “at least on of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein.

In order to meet requirements for the compression speed and compression efficiency, a memory storage apparatus disposed with a compression/decompression circuit having a better compression speed and a compression/decompression circuit having a better compression rate is provided according to the exemplary embodiments of the invention. One of the compression/decompression circuits is selected to process data according to a pattern of the data. Specifically, when data is received (step S101), whether the data belongs to a first pattern or a second pattern is identified (step S103). If the data belongs to the first pattern, a first compression/decompression circuit is used to compress the data to generate compressed data, and the compressed data is written into physical programming units (step S105). If the data belongs to the second pattern, a second compression/decompression circuit is used to compress the data to generate another compressed data, and the another compressed data is written into the physical programming units (step S107), wherein a compression speed of the first compression/decompression circuit is higher than a compression speed of the second compression/decompression circuit, and a data compression rate of the first compression/decompression circuit is lower than a data compression rate of the second compression/decompression circuit. For better understanding of the techniques provided by the invention, several exemplary embodiments are provided with reference to the accompanying drawings to describe the present invention.

### First Embodiment

Generally, a memory storage apparatus (which is also referred to as a memory storage system) includes a rewritable non-volatile memory module and a controller (which is also referred to as a control circuit). The memory storage apparatus is commonly used with a host system, such that the host system may write data into or read data from the memory storage apparatus.

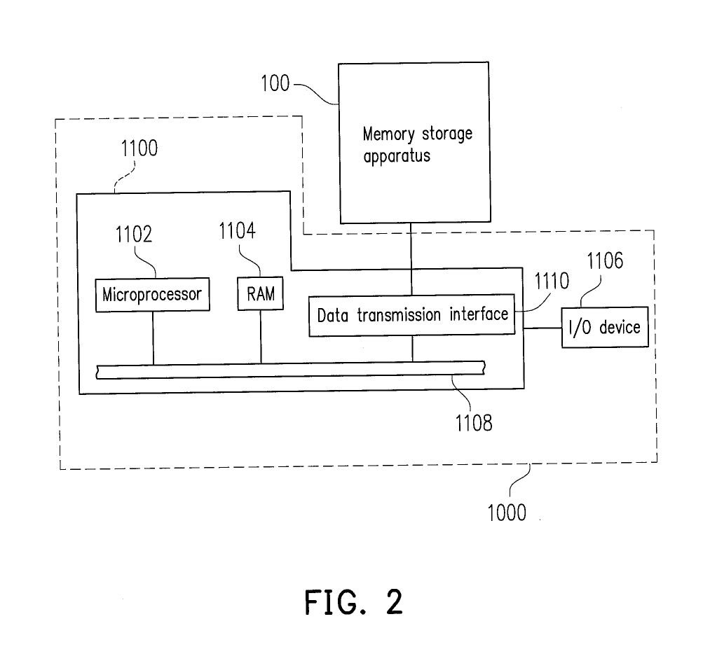

FIG. 2 illustrates a host system and a memory storage apparatus according to an exemplary embodiment.

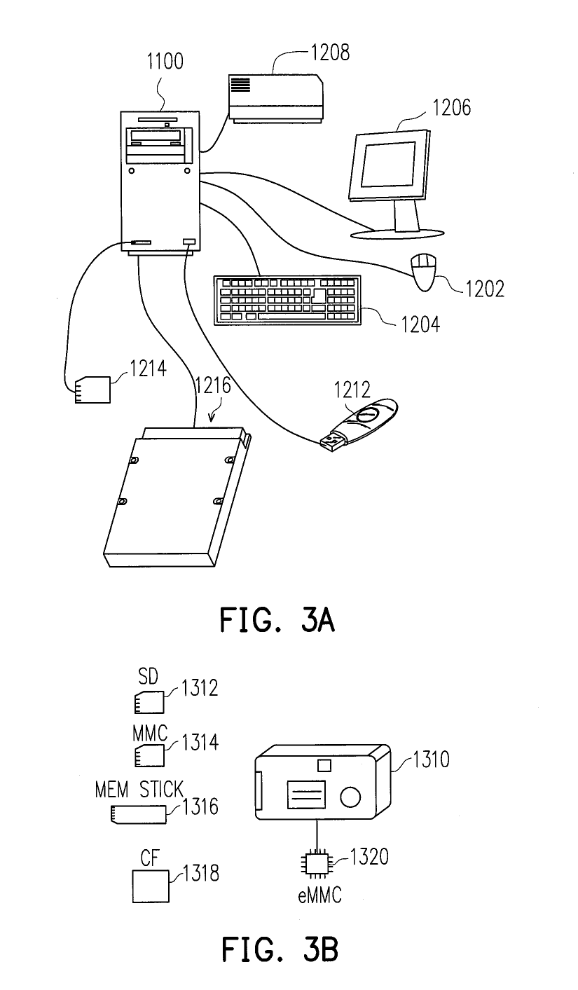

With reference to FIG. 2, a host system 1000 generally includes a computer 1100 and an input/output (I/O) apparatus 1106. The computer 1100 includes a microprocessor 1102, a random access memory (RAM) 1104, a system bus 1108, and a data transmission interface 1110. The I/O device 1106 includes a mouse 1202, a keyboard 1204, a display 1206, and a printer 1208, as shown in FIG. 3A. It should be understood that the devices illustrated in FIG. 3A do not limit the I/O device 1106, and the I/O device 1106 may further include other devices.

In the present exemplary embodiment, a memory storage apparatus 100 is coupled to other components of the host system 1000 through the data transmission interface 1110. With the operations of the microprocessor 1102, the RAM 1104, and the I/O device 1106, data can be written into or read from the memory storage apparatus 100. For instance, the memory storage apparatus 100 may be a rewritable non-volatile memory storage apparatus, such as a flash drive 1212, a memory card 1214, or a solid state drive (SSD) 1216 illustrated in FIG. 3A.

Generally speaking, the host system 1000 can be substantially any system that works with the memory storage device 100 to store data. Even though the host system 1000 is described as a computer system in the present exemplary embodiment, in another exemplary embodiment of the invention, the host system 1000 may also be a digital camera, a video camera, a communication apparatus, an audio player, or a video player. For example, if the host system is a digital camera (video camera) 1310, the rewritable non-volatile memory storage apparatus is then a secure digital (SD) card 1312, a multi media card (MMC) card 1314, a memory stick (MS) 1316, a compact flash (CF) card 1318, or an embedded storage device 1320 (as shown in FIG. 3B) used by the digital camera (video camera) 1310. The embedded storage device 1320 includes an embedded MMC (eMMC). It should be mentioned that an eMMC is directly coupled to the motherboard of a host system.

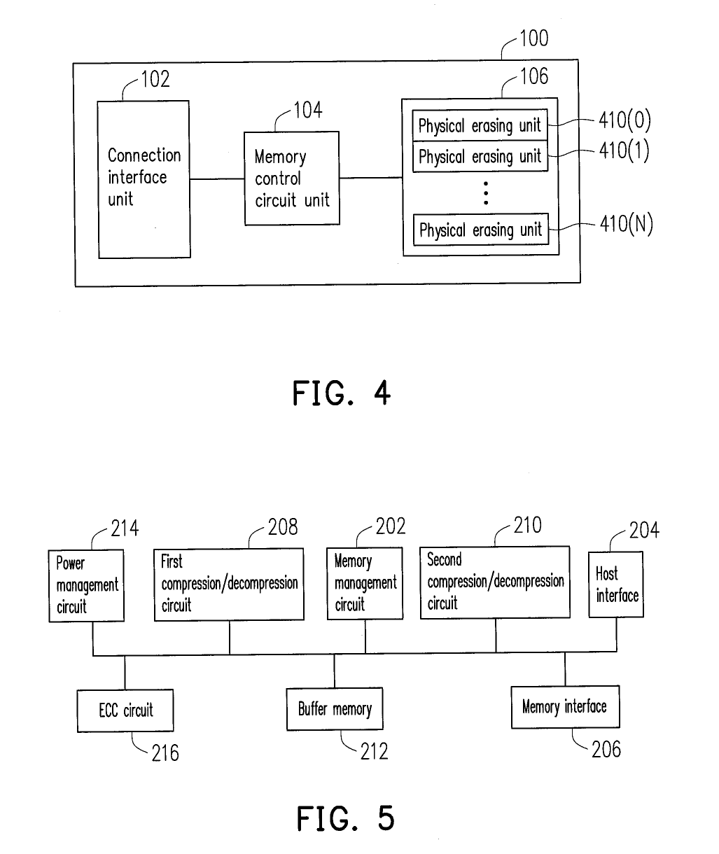

FIG. 4 is a schematic block diagram illustrating a memory storage apparatus according to a first exemplary embodiment.

With reference to FIG. 4, the memory storage apparatus 100 includes a connection interface unit 102, a memory control circuit unit 104 and a rewritable non-volatile memory module 106.

In the present exemplary embodiment, the connection interface unit 102 complies with the serial advanced technology attachment (SATA) standard. However, the invention is not limited thereto, and the connection interface unit 102 may also comply with the parallel advanced technology attachment (PATA) standard, the Institute of Electrical and Electronic Engineers (IEEE) 1394 standard, the peripheral component interconnect (PCI) express standard, the universal serial bus (USB) standard, the ultra high speed-I (UHS-I) interface standard, the ultra high speed-II (UHS-II) interface standard, the secure digital (SD) interface standard, the memory stick (MS) interface standard, the multi media card (MMC) interface standard, the compact flash (CF) interface standard, the integrated device electronics (IDE) standard, or any other suitable standard. In the present exemplary embodiment, the connection interface unit and the memory control circuit unit may be packaged into one chip, or the connection interface unit is distributed outside of a chip containing the memory control circuit unit.

The memory control circuit unit 104 is configured to execute a plurality of logic gates or control instructions which are implemented in a hardware form or in a firmware form and perform operations of writing, reading or erasing data in the rewritable non-volatile memory storage module 106 according to the commands of the host 1000.

The rewritable non-volatile memory storage module 106 is coupled to the memory control circuit unit 104 and configured to store data written from the host system 1000. The rewritable non-volatile memory module 106 has physical erasing unit 410(0) to 410(N). For example, the physical erasing unit 410(0) to 410(N) may belong to the same memory die or belong to different memory dies. Each physical erasing unit has a plurality of physical programming units, and the physical programming units of the same physical erasing unit may be written separately and erased simultaneously. For example, each physical erasing unit is composed by 128 physical programming units. Nevertheless, it should be understood that the invention is not limited thereto. Each physical erasing unit is composed by 64 physical programming units, 256 physical programming units or any amount of the physical programming units.

In more detail, a physical erasing unit is the smallest unit for erasing. Namely, each of the physical erasing units has the least number of memory cells for being erased altogether. A physical programming unit is the smallest unit for programming. Namely, each of the physical programming units is the smallest unit for writing data. Each physical programming unit commonly includes a data but area and a redundant bit area. The data bit area includes a plurality of physical access addresses for storing user data, and the redundant bit area is used for storing system data (e.g., control information and an error checking and correcting (ECC) code). In the present exemplary embodiment, the data bit area of each physical programming unit contains 4 physical access addresses, and the size of each physical access address is 512 bytes (B). However, in other exemplary embodiments, a data bit area may also contain less or more physical access addresses, and the invention is not intended to limit the size and number of the physical access addresses. For example, in an exemplary embodiment, the physical erasing units may be physical blocks, and the physical programming units may be physical pages or physical sectors, but the invention is not limited thereto.

In the present exemplary embodiment, the rewritable non-volatile memory module 106 is a multi level cell (MLC) NAND flash memory module (i.e., each memory cell can store data of two bits). However, the invention is not limited thereto. The rewritable non-volatile memory module 106 may also be a single level cell (SLC) NAND flash memory module (i.e., each memory cell can store data of one bit), a trinary level cell (TLC) NAND flash memory module (i.e., each memory cell can store data of three bits) or any other flash memory module having the same characteristics.

FIG. 5 is a schematic block diagram illustrating a memory control circuit unit according to the first exemplary embodiment.

With reference to FIG. 5, the memory control circuit unit 104 includes a memory management circuit 202, a host interface 204, a memory interface 206, a first compression/decompression circuit 208 and a second compression/decompression circuit 210.

The memory management circuit 202 is configured to control the overall operation of the memory control circuit unit 104. Specifically, the memory management circuit 202 has a plurality of control instructions, and when the memory storage apparatus 100 is in operation, the control instructions are executed to issue a command sequence to the rewritable non-volatile memory module 106, so as to perform operations, such as writing data into, reading data from or erasing data from the rewritable non-volatile memory module 106.

In the present exemplary embodiment, the control instructions of the memory management circuit 202 are implemented in a firmware form. For example, the memory management circuit 202 has a microprocessor unit (not shown) and a read-only memory (ROM, not shown), and the control instructions are burnt into the ROM. When the memory storage apparatus 100 is in operation, the control instructions are executed by the microprocessor unit to perform operations, such as data writing, reading or erasing.

In another exemplary embodiment of the invention, the control instructions of the memory management circuit 202 may also be stored in a specific area of the rewritable non-volatile memory module 106 (for example, a system area exclusively used for storing system data in a memory module) as program codes. In addition, the memory management circuit 202 has a microprocessor unit (not shown), a ROM (not shown), and a RAM (not shown). In particular, the ROM has a boot code. When the memory control circuit unit 104 is enabled, the microprocessor unit first executes the boot code to load the control instructions from the rewritable non-volatile memory module 106 into the RAM of the memory management circuit 202. Thereafter, the microprocessor unit runs the control instructions to perform data writing, reading, and erasing operations.

Additionally, in another exemplary embodiment of the invention, the control instructions of the memory management circuit 202 may also be implemented in a hardware form. For example, the memory management circuit 202 includes a microcontroller, a memory cell management circuit, a memory writing circuit, a memory reading circuit, a memory erasing circuit, and a data processing circuit. The memory cell management circuit, the memory writing circuit, the memory reading circuit, the memory erasing circuit, and the data processing circuit are coupled to the microcontroller. The memory cell management circuit is configured to manage the physical erasing units of the rewritable non-volatile memory module 106. The memory writing circuit is configured to issue a write command to the rewritable non-volatile memory module 106 to write data into the rewritable non-volatile memory module 106. The memory reading circuit is configured to issue a read command to the rewritable non-volatile memory module 106 to read data from the rewritable non-volatile memory module 106. The memory erasing circuit is configured to issues an erase command to the rewritable non-volatile memory module 106 to erase data from the rewritable non-volatile memory module 106. The data processing circuit is configured to process data to be written into the rewritable non-volatile memory module 106 or data read from rewritable non-volatile memory module 106.

The host interface 204 is coupled to the memory management circuit 202 and configured to receive and identify commands and data transmitted from the host system 1000. That is, the commands and data transmitted by the host system 1000 are sent to the memory management circuit 202 through the host interface 204. In the present exemplary embodiment, the host interface 204 complies with the SATA standard. However, the present invention is not limited thereto, and the host interface 204 may also comply with the PATA standard, the IEEE 1394 standard, the PCI express standard, the USB standard, the UHS-I standard, the UHS-II standard, the SD standard, the MS standard, the MMC standard, the eMMC standard, the CF standard, the IDE standard, or any other suitable data transmission standard.

The memory interface 206 is coupled to the memory management circuit 202 and configured to access the rewritable non-volatile memory module 106. Namely, data to be written into the rewritable non-volatile memory module 106 is converted by the memory interface 206 into a format acceptable to the rewritable non-volatile memory module 106.

The first compression/decompression circuit 208 and the second compression/decompression circuit 210 are coupled to the memory management circuit 202 and configured to compress or decompress input data according to commands of the memory management circuit 202. In the present exemplary embodiment, a compression speed of the first compression/decompression circuit 208 is higher than a compression speed of the second compression/decompression circuit 210, but a compression rate of the first compression/decompression circuit 208 is lower than a compression rate of the second compression/decompression circuit 210. Specifically, a compression mechanism utilized by the first compression/decompression circuit 208 may perform the compression in a higher speed, but compress data with less compression efficiency. The second compression/decompression circuit 202 has a slower compression speed, but may compress data with better compression efficiency. For example, in a case that the first compression/decompression circuit 208 is used to compress data of 2 kilobytes (KB), a time required for the compression may be 1 microsecond (μs) and compressed data of 1 KB may be generated. Nevertheless, in a case that the second compression/decompression circuit 202 is used to compress the same data, a time required for the compression may be 2 μs, and compressed data of 512 bytes may be generated. For example, in an exemplary embodiment, the first compression/decompression circuit 208 may be implemented as a compression circuit using the Lempel-Ziv (LZ) algorithm mechanism, and the second compression/decompression circuit 202 may be implemented as a compression circuit using the Hu man algorithm mechanism.

In an exemplary embodiment, the memory control circuit unit 104 may also include a buffer memory 208, a power management circuit 210 and an error checking and correcting (ECC) circuit 216.

The buffer memory 212 is coupled to the memory management circuit 202 and configured to temporarily store data and commands from the host system 1000 or data from the rewritable non-volatile memory module 106.

The power management circuit 214 is coupled to the memory management circuit 202 and configured to control the power supply of the memory storage apparatus 100.

The ECC circuit 216 is coupled to the memory management circuit 202 and configured to perform an ECC procedure to ensure data accuracy. To be specific, when the memory management circuit 202 receives a write command from the host system 1000, the ECC circuit 216 generates a corresponding ECC code for the data corresponding to the write command. The memory management circuit 202 writes the data and the ECC code corresponding to the write command into the rewritable non-volatile memory module 106. Subsequently, when reading the data from the rewritable non-volatile memory module 106, the memory management circuit 202 also reads the ECC code corresponding to the data, and the ECC circuit 216 performs the ECC procedure on the data according to the ECC code.

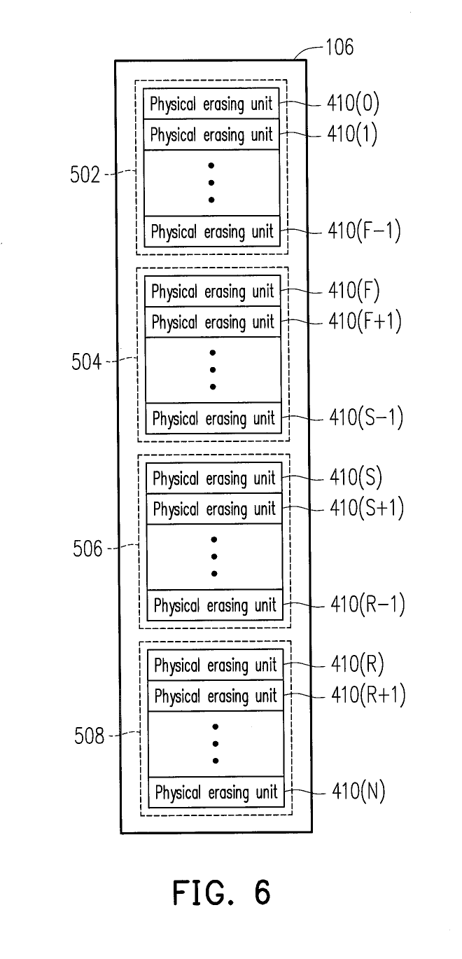

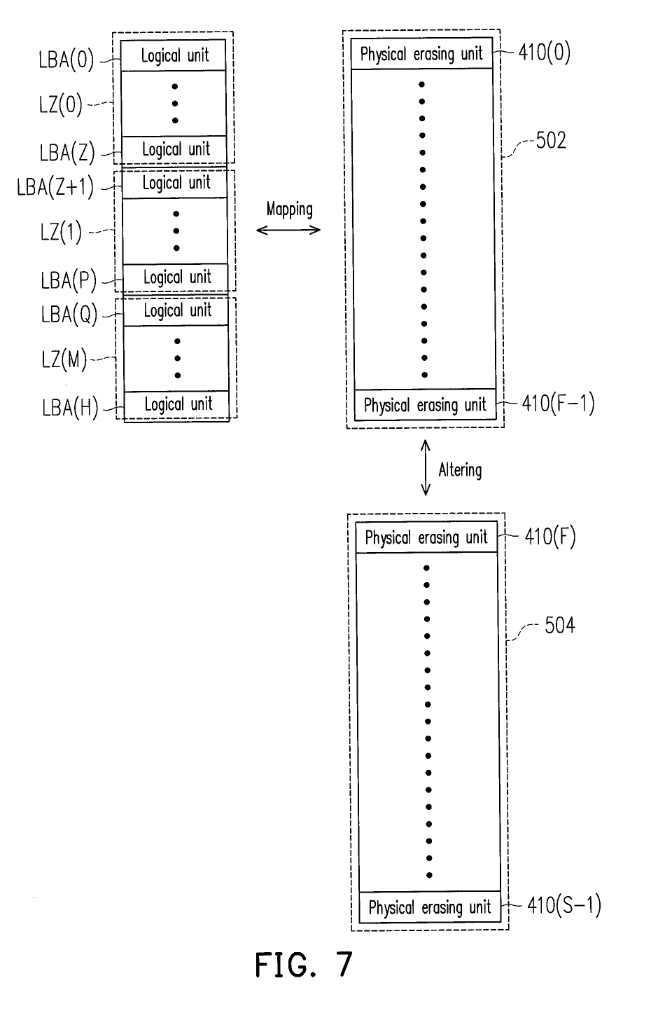

FIG. 6 and FIG. 7 are schematic diagrams illustrating examples of managing the physical blocks according to the first exemplary embodiment of the invention.

With reference to FIG. 6, the memory control circuit unit 104 (or the memory management circuit 202) logically partitions the physical erasing unit 410(0) to 410-(N) into a data area 502, a spare area 504, a system area 506 and a replacement area 508.

The physical erasing units logically belonging to the data area 502 and the spare area 504 are used to store data from the host system 1000. Specifically, a physical erasing units belonging to the data area 502 are considered as a physical erasing unit of stored data, and a physical erasing unit belonging to the spare area 504 are used to replace a physical erasing units belonging to the data area 502. In other words, when a write command and data to be written are received from the host system 1000, the memory management circuit 202 selects a physical erasing unit from the spare area 504 and writes the data into the selected physical erasing unit in replacement with a physical erasing unit belonging to the data area 502.

The physical erasing units logically belonging to the system area 506 are used to record system data. For example, the system data includes the manufacturers and models regarding the rewritable non-volatile memory modules, the number of physical erasing units in the rewritable non-volatile memory modules, the number of physical programming units in each physical erasing unit.

The physical erasing units logically belonging to the replacement area 508 are used for a bad physical erasing unit replacement procedure for replacing damaged physical erasing units. Particularly, if there are still normal physical erasing units in the replacement area 508, and a physical erasing unit belonging to the data area 502 is damaged, the memory management circuit 202 gets a normal physical erasing unit from the replacement area 1408 to replace the damaged physical erasing unit.

Specially, the numbers of the physical erasing units in the data area 502, the spare area 504, the system area 506 and the replacement area 508 vary with different memory module standards. Additionally, it has to be understood that the grouping relations of grouping the physical erasing units into the data area 502, the spare area 504, the system area 506 and the replacement area 508 are dynamically changed during the operations of the memory storage apparatus 100. For example, when a physical erasing unit in the spare area 504 is damaged and replaced by a physical erasing unit in the replacement area 508, the physical erasing unit in the replacement area 508 is associated with the spare area 504.

With reference to FIG. 7, the memory control circuit unit 104 (or the memory management circuit 202) configures a plurality of logical units LBA(0) to LBA(H) for mapping the physical erasing units of the data area 502, in which each logical unit includes a plurality of logical sub-units for orderly mapping to the physical programming units of the corresponding physical erasing units. Also, when the host system is to write data into a logical unit or update the data stored in a logical unit, the memory control circuit unit 104 (or the memory management circuit 202) may select a physical erasing unit to write the data for altering the physical erasing units belonging to the data area 502. In the present exemplary embodiment, each logical sub-unit may be a logical page or a logical sector.

In order to identify that in which physical erasing unit the data of each logical unit is stored, in the present exemplary embodiment, the memory control circuit unit 104 (or the memory management circuit 202) may record the mapping relation between logical units and physical erasing units. Also, when the host system 1000 is about to access data from a logical sub-unit, the memory control circuit unit 104 (or the memory management circuit 202) may identify which logical unit this logical sub-unit belongs to and access data from the physical erasing unit mapped to this logical unit. For example, in the present exemplary embodiment, the memory control circuit unit 104 (or the memory management circuit 202) may store a logical address-physical address mapping table in the rewritable non-volatile memory module 106 to record the physical erasing units mapped to each logical unit, and when being about to access data, the memory control circuit unit 104 (or the memory management circuit 202) may load the logical address-physical address mapping table into the buffer memory 208 for maintaining.

It should be mentioned that, because the limited capacity of the buffer memory 208 cannot record the mapping tables of mapping relation of all logical units, in the present exemplary embodiment, the memory control circuit unit 104 (or the memory management circuit 202) may group the logical units LBA(0) to LBA(H) into a plurality of logical areas LZ(0) to LZ(M), and may configure a logical address-physical address mapping table for each logical area. Particularly, when the memory control circuit unit 104 (or memory management circuit 202) is about to update a mapping of a certain logical unit, the logical address-physical address mapping table corresponding to the logical area which this logical unit belongs to may be loaded into the buffer memory 208 to be updated.

In the present exemplary embodiment, the management of the rewritable non-volatile memory module 106 of the memory storage apparatus 100 is performed based on the physical programming units, which is also referred to as page-based management. Thus, when a write command is executed, no matter what logical sub-unit of a logical unit the data is about to be written into, the memory control circuit unit 104 (or the memory management circuit 202) may write data in a manner of one physical programming unit following another physical programming unit (which is referred to as a random writing mechanism hereinafter). Specifically, the memory control circuit unit 104 (or the memory management circuit 202) may select an empty physical erasing unit from the spare area 504 to serve it as a currently active physical erasing unit to write data. Meanwhile, when the currently active physical erasing unit is full, the memory control circuit unit 104 (or the memory management circuit 202) may further select another empty physical erasing unit from the spare area 504 to serve it as the currently active physical erasing unit to continuously write the data corresponding to the write command from the host system 1000. Specially, in order to prevent the physical erasing units belonging to the spare area 504 from being exhausted, when the memory control circuit unit 104 (or the memory management circuit 202) is about to select a physical erasing unit from the spare area 504, and the number of the physical erasing units belonging to the spare area 504 in reduced down to a set garbage collection threshold, the memory control circuit unit 104 (or the memory management circuit 202) may first execute a data merge operation, and thereby, the data in at least one of the physical erasing units in the data area 502 becomes invalid data, such that the physical erasing units storing the data that all becomes invalid data are associated back to the spare area 504, which leads the number of the physical erasing units belonging to the spare area 504 to be greater than the set garbage collection threshold. For example, during the execution of the data merge operation, the memory control circuit unit 104 (or the memory management circuit 202) requires at least one empty physical erasing unit, and thus, the garbage collection threshold is at least set to a number greater than 1.

Specially, in the present exemplary embodiment, if the memory management circuit 202 receives a write command from the host system 1000, and the write command instructs to write data into the logical sub-units, the memory management circuit 202 may instruct (or use) the first compression/decompression circuit 208 to compress the data corresponding to the write command and writes the compressed data into the rewritable non-volatile memory module 106. That is, in this state, the write data received from the host system 1000 conforms to said first pattern. Additionally, if the memory management circuit 202 reads data from a certain physical programming unit and is to write the data into another physical programming unit, the memory management circuit 202 may instruct (or use) the second compression/decompression circuit 210 to compress the data corresponding to the write command. That is, in this state, the data to be moved which is read from the rewritable non-volatile memory module 106 conforms to said second pattern.

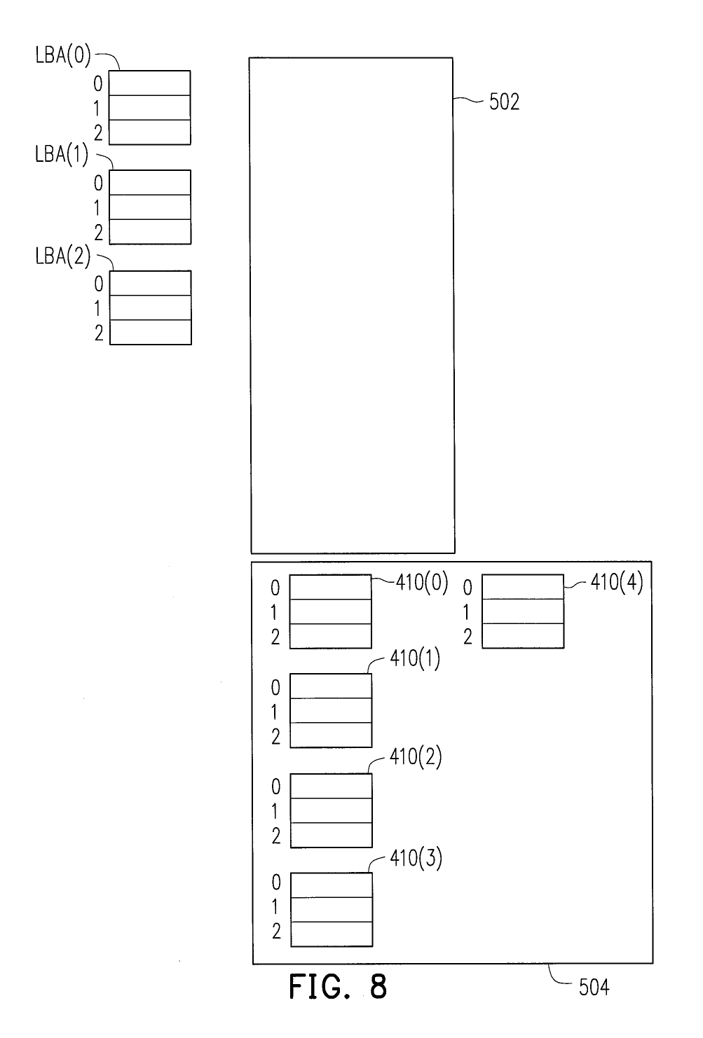

FIG. 8 to FIG. 20 illustrate examples of writing data according to the first exemplary embodiment.

With reference to FIG. 8, for descriptive convenience, it is assumed that there is no physical erasing units mapped to the logical units initially (i.e., the memory storage apparatus 100 is never written with the user data after the memory module is set up) in the data area 502, the spare area 504 has 5 physical erasing units, each physical erasing unit has 3 physical programming units, and the data to be written into each physical erasing unit has to be written according to the order of the physical programming units. Additionally, it is assumed that the memory control circuit unit 104 (or the memory management circuit 202) configures 3 logical units for the host system 1000 to access and sets the garbage collection threshold as 1, in which each logical unit has 3 logical sub-units, and the capacity of each logical sub-unit is equal to the capacity of 1 physical programming unit.

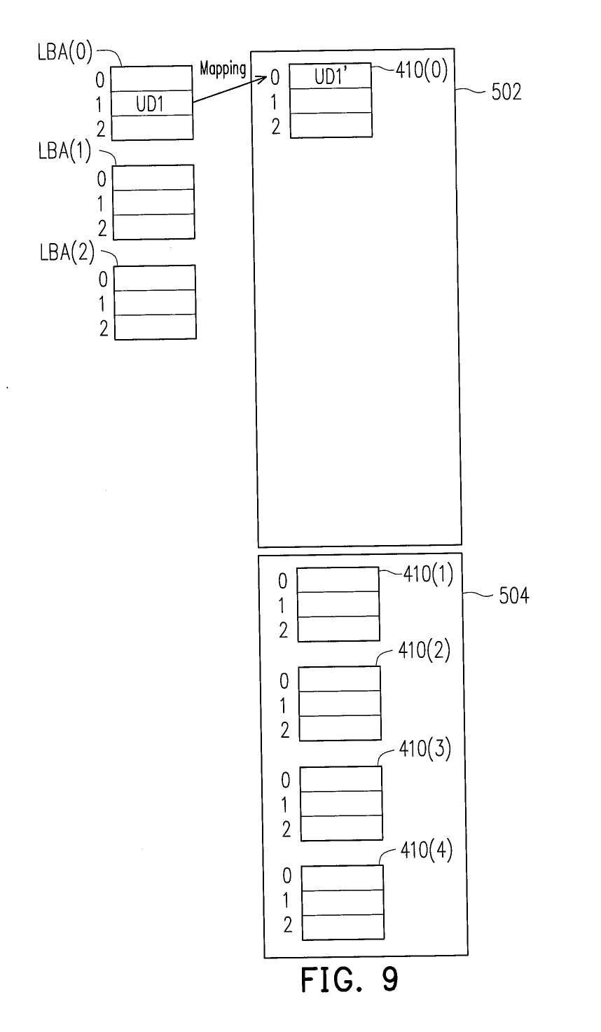

With reference to FIG. 9, if it is assumed that data UD1 is to be programmed, and the data UD1 belongs to the first logical sub-unit of the logical unit LBA(0), the memory control circuit unit 104 (or the memory management circuit 202) may select the physical erasing unit 410(0) from the spare area 504, use the first compression/decompression circuit 208 to compress the data UD1 in to compressed data UD1′, issue a program command to write the data UD1′ into the 0^{th} physical programming unit of the physical erasing unit 410(0) and associate the physical erasing unit 410(0) with the data area 502.

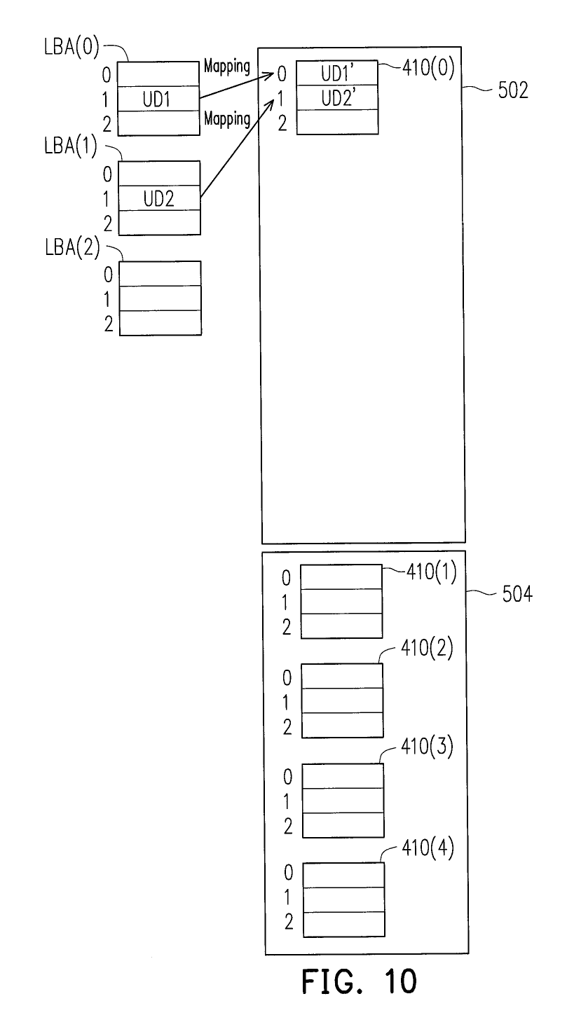

With reference to FIG. 10, following FIG. 9, if it is assumed that data UD2 is further to be programmed, and the data UD2 belongs to the 0^{th} logical sub-unit of the logical unit LBA(1), the memory control circuit unit 104 (or the memory management circuit 202) may use the first compression/decompression circuit 208 to compress the data UD2 into compressed data UD2′, issue a program command to write the data UD2′ into the 1^{st} physical programming unit of the physical erasing unit 410(0).

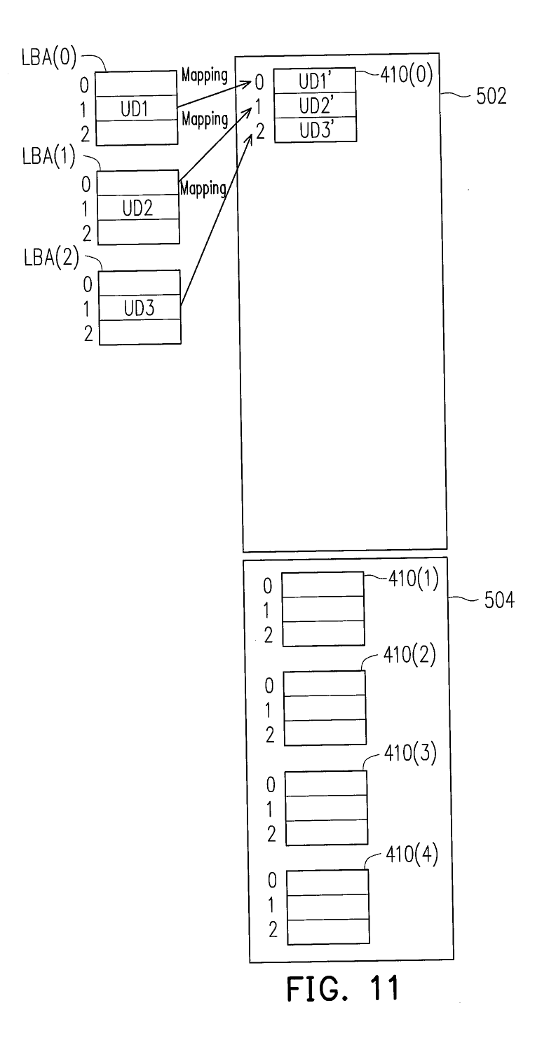

With reference to FIG. 11, following FIG. 10, if it is assumed that data UD3 is further to be programmed, and the data UD3 belongs to the first logical sub-unit of the logical unit LBA(2), the memory control circuit unit 104 (or the memory management circuit 202) may use the first compression/decompression circuit 208 to compress the data UD3 into compressed data UD3′, issue a program command to write the data UD3′ into the 2^{nd} physical programming unit of the physical erasing unit 410(0).

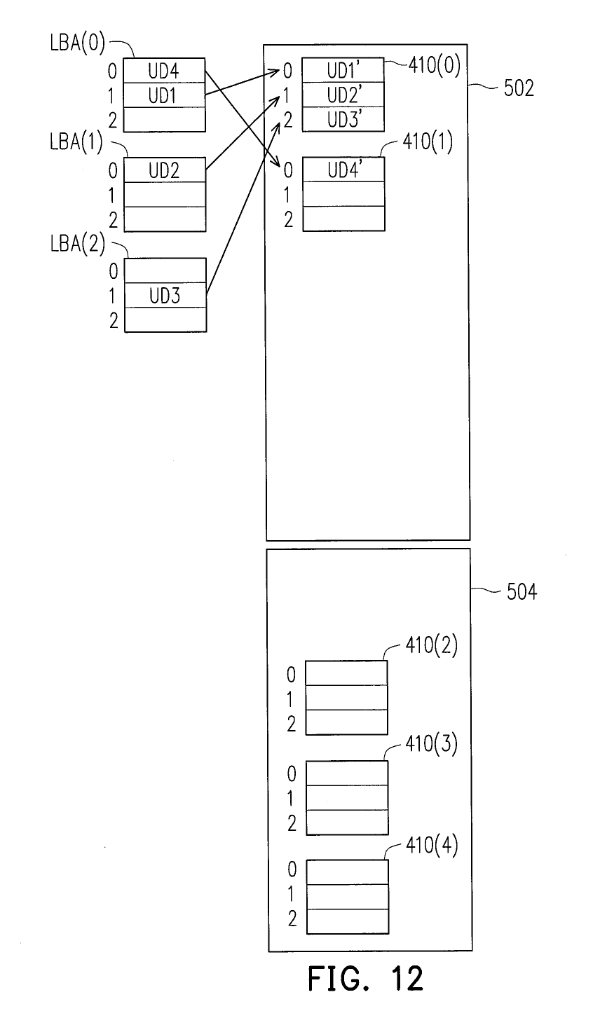

With reference to FIG. 12, following FIG. 11, if it is assumed that data UD4 is further to be programmed, and the data UD4 belongs to the 0^{th} logical sub-unit of the logical unit LBA(0), since there is no more storage space in the physical erasing unit 410(0), the memory control circuit unit 104 (or the memory management circuit 202) may select a physical erasing unit 410(1) from the spare area 504, use the first compression/decompression circuit 208 to compress the data UD4 into compressed data UD4′, issue a program command to write the data UD4′ into the 0^{th} physical programming unit of the physical erasing unit 410(1) and associate the physical erasing unit 410(1) with the data area 502.

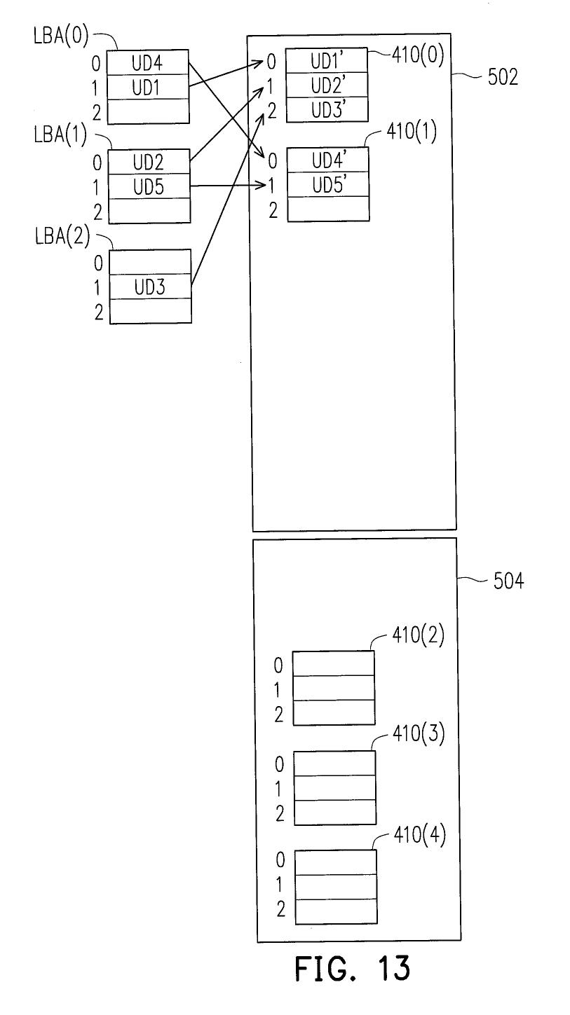

With reference to FIG. 13, following FIG. 12, if it is assumed that data UD5 is further to be programmed, and the data UD5 belongs to the first logical sub-unit of the logical unit LBA(1), the memory control circuit unit 104 (or the memory management circuit 202) may use the first compression/decompression circuit 208 to compress the data UD5 into compressed data UD5′, issue a program command to write the data UD5′ into the 1^{st} physical programming unit of the physical erasing unit 410(1).

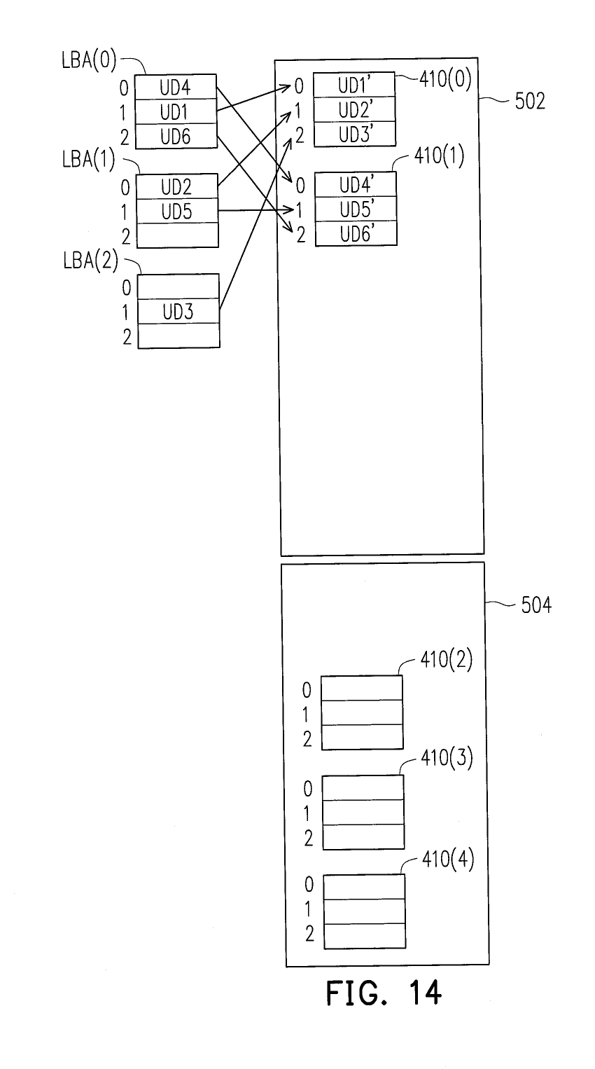

With reference to FIG. 14, following FIG. 13, if it is assumed that data UD6 is further to be programmed, and the data UD6 belongs to the second logical sub-unit of the logical unit LBA(0), the memory control circuit unit 104 (or the memory management circuit 202) may use the first compression/decompression circuit 208 to compress the UD6 into compressed data UD6′, issue a program command to write the data UD6′ into the 2^{nd} physical programming unit of the physical erasing unit 410(1).

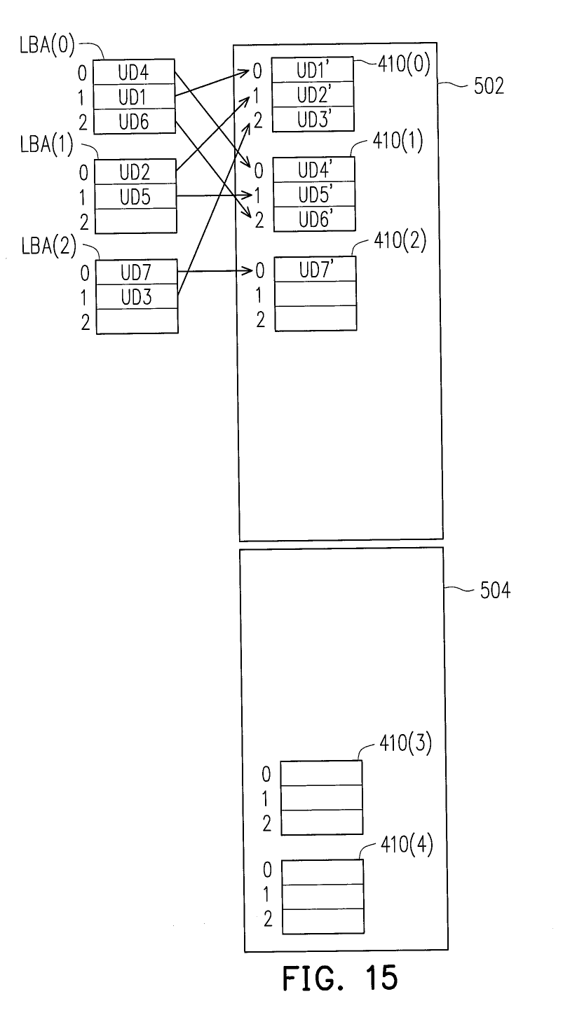

With reference to FIG. 15, following FIG. 14, if it is assumed that data UD7 is further to be programmed, and the data UD4 belongs to the 0^{th} logical sub-unit of the logical unit LBA(2), since there is no more storage space in the physical erasing unit 410(1), the memory control circuit unit 104 (or the memory management circuit 202) may select the physical erasing unit 410(2) from the spare area 504, use the first compression/decompression circuit 208 to compress the UD7 into compressed data UD7′, issue a program command to write the data UD7′ into the 0^{th} physical programming unit of the physical erasing unit 410(2) and associate the physical erasing unit 410(2) with the data area 502.

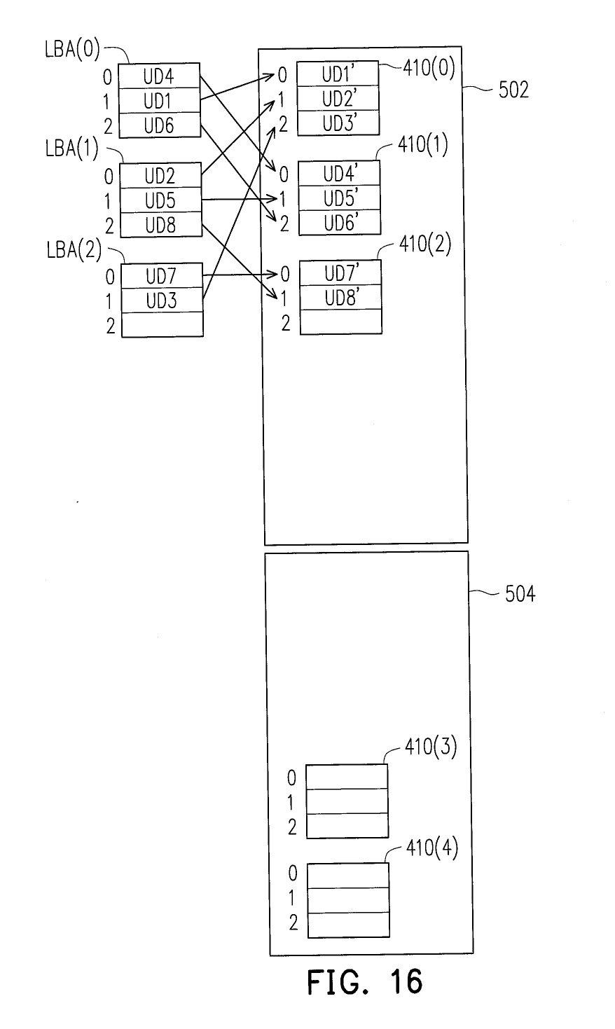

With reference to FIG. 16, following FIG. 15, if it is assumed that data UD8 is further to be programmed, and the data UD8 belongs to the second logical sub-unit of the logical unit LBA(1), the memory control circuit unit 104 (or the memory management circuit 202) may use the first compression/decompression circuit 208 to compress the UD8 into compressed data UD8′, issue a program command to write the data UD8′ into the 1^{st} physical programming unit of the physical erasing unit 410(2).

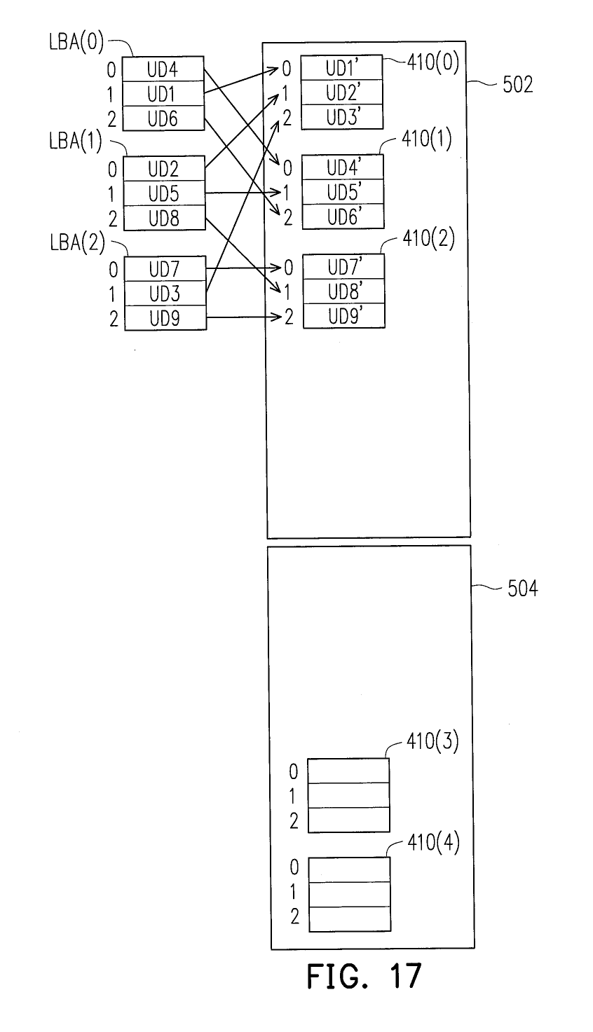

With reference to FIG. 17, following FIG. 16, if it is assumed that data UD9 is further to be programmed, and the data UD9 belongs to the second logical sub-unit of the logical unit LBA(2), the memory control circuit unit 104 (or the memory management circuit 202) may use the first compression/decompression circuit 208 to compress the UD9 into compressed data UD9′, issue a program command to write the data UD9 into the 2^{nd} physical programming unit of the physical erasing unit 410(2).

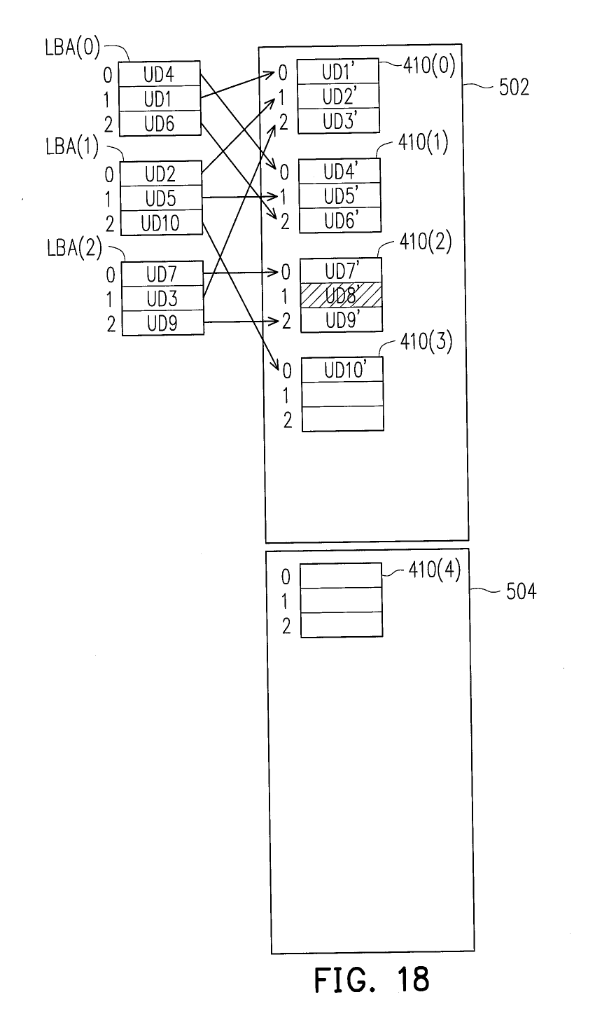

With reference to FIG. 18, following FIG. 17, if it is assumed that data UD10 is further to be programmed, and the data UD10 belongs to the second logical sub-unit of the logical unit LBA(1), since there is no more storage space in the physical erasing unit 410(2), the memory control circuit unit 104 (or the memory management circuit 202) may select the physical erasing unit 410(3) from the spare area 504, use the first compression/decompression circuit 208 to compress the UD10 into compressed data UD10′, issue a program command to write the data UD10′ into the 0^{th} physical programming unit of the physical erasing unit 410(3) and associate the physical erasing unit 410(3) with the data area 502. Therein, the 1^{st} physical programming unit of the physical erasing unit 410(2) may be marked in an invalid data state (illustrated as the dotted line).

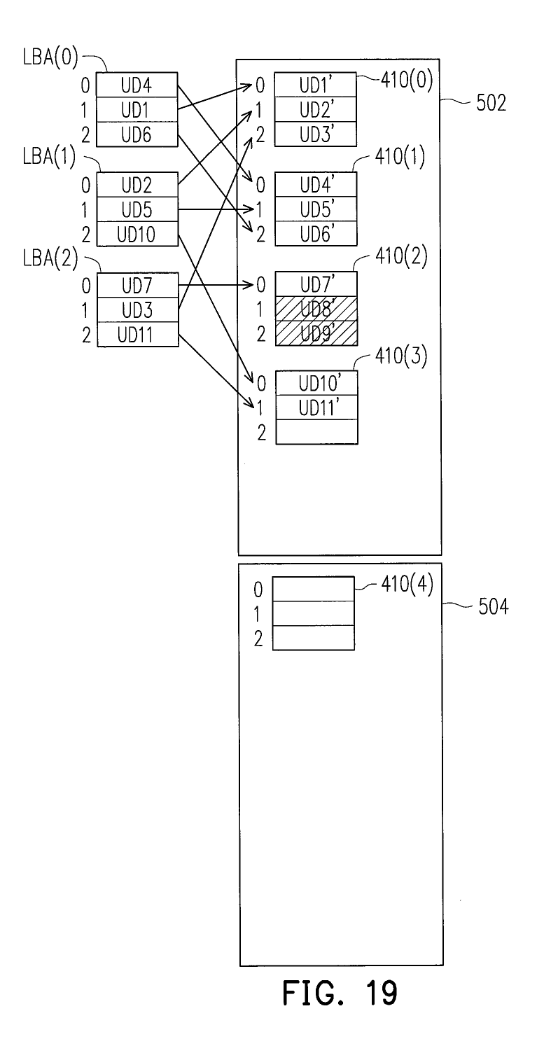

With reference to FIG. 19, following FIG. 18, if it is assumed that data UD11 is further to be programmed, and the data UD11 belongs to the second logical sub-unit of the logical unit LBA(2), the memory control circuit unit 104 (or the memory management circuit 202) may use the first compression/decompression circuit 208 to compress the UD11 into compressed data UD11′, issue a program command to write the data UD11′ into the 1^{st} physical programming unit of the physical erasing unit 410(3). Therein, the 2^{nd} physical programming unit of the physical erasing unit 410(2) is marked in the invalid data state (illustrated as the dotted line).

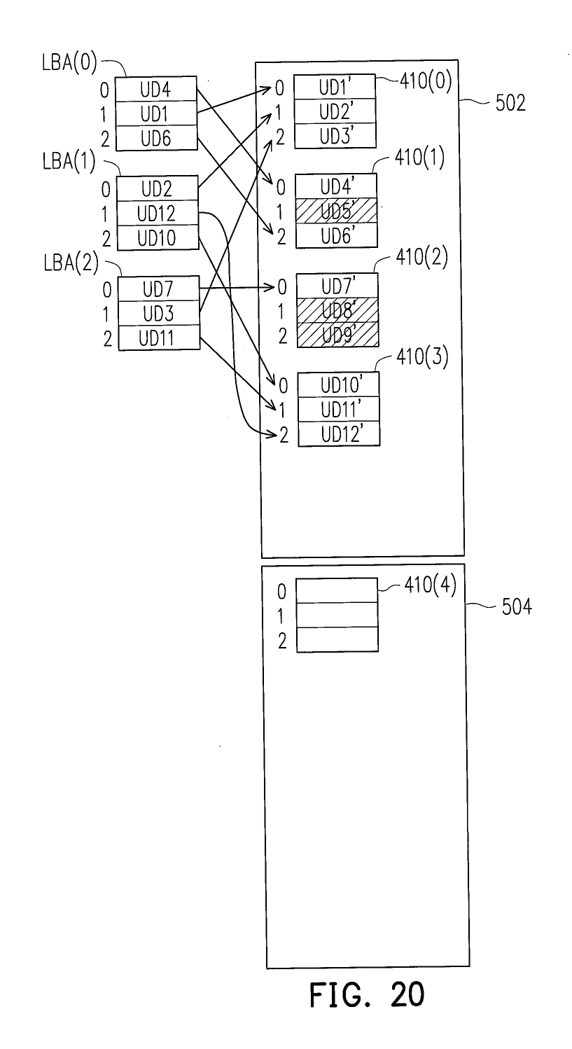

With reference to FIG. 20, following FIG. 19, if it is assumed that data UD12 is further to be programmed, and the data UD12 belongs to the first logical sub-unit of the logical unit LBA(1), the memory control circuit unit 104 (or the memory management circuit 202) may use the first compression/decompression circuit 208 to compress the UD12 into compressed data UD12′, issue a program command to write the data UD12′ into the 2^{nd} physical programming unit of the physical erasing unit 410(3). Therein, the 1^{st} physical programming unit of the physical erasing unit 410(1) is marked in the invalid data state (illustrated as the dotted line).

In the same way, no matter which logical sub-unit of the logical unit the host system 1000 is to store the data in, the memory control circuit unit 104 (or the memory management circuit 202) may sequentially write the data to be stored by the host system 1000 into the currently active physical erasing unit. Specially, when the number of the physical erasing units belonging to the spare area 504 is not greater than the garbage collection threshold, the memory control circuit unit 104 (or the memory management circuit 202) may perform the data merge operation while executing the write command, so as to prevent the physical erasing units in the spare area from being used up.

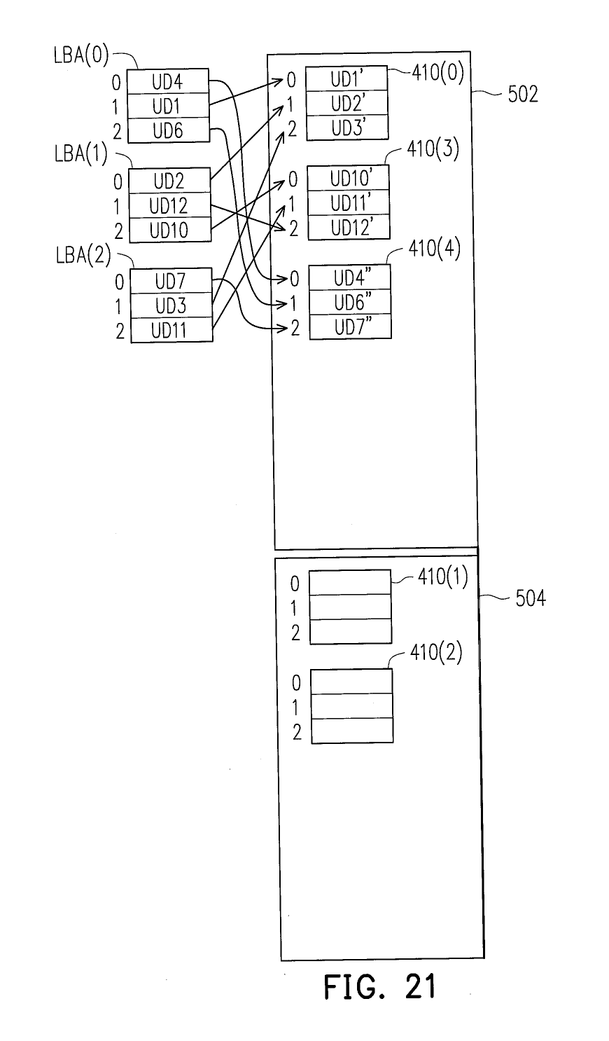

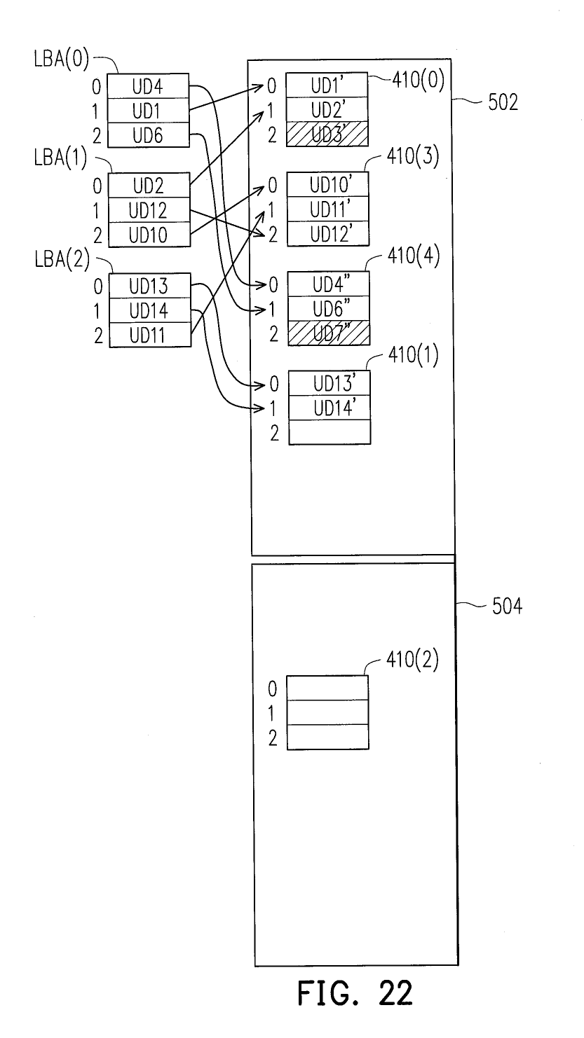

FIG. 21 and FIG. 22 illustrate simplified examples of performing a data merge procedure to complete the subsequent write commands according to the first exemplary embodiment.

Following FIG. 20, if it is assumed that data UD13 and UD14 are further to be programmed, and the data UD13 and the data UD14 belong to the 0^{th} and the first logical sub-units of the logical unit LBA(2), since there is no more storage space in the physical erasing unit 410(3), the memory control circuit unit 104 (or the memory management circuit 202) has to select an empty physical erasing unit from the spare area 504. However, in this occasion, the number of the physical erasing units belonging to the spare area 504 is not greater than the garbage collection threshold, and thus, the memory control circuit unit 104 (or the memory management circuit 202) has to perform the data merge operation first.

With reference to FIG. 21, for example, the memory control circuit unit 104 (or the memory management circuit 202) may select the physical erasing units 410(4) from the spare area 504, read valid data (i.e., the data UD4′ and the data UD6′) from the physical erasing unit 410(1) and valid data (i.e., the data UD7′) from the physical erasing unit 410(2), use the first compression/decompression circuit 208 to decompress the data UD4′, the data UD6′ and the data UD7′ back to the data UD4, the data UD6 and the data UD7, use the second compression/decompression circuit 210 to compress the data UD4, the data UD6 and the data UD7 to generate data UD4″, data UD6″ and data UD7″, write the data UD4″, the data UD6″ and the data UD7″ into the physical erasing units 410(4), associate the physical erasing units 410(4) with the data area 502, mark the 0^{th} and the physical programming units of the 1^{st} physical erasing unit 410(1) and the 0^{th} physical programming unit of the physical erasing unit 410(2) as invalid, perform a physical erasing operation on the physical erasing units storing only the invalid data (i.e., the physical erasing units 410(1) and 410(2)) and associate the erased physical erasing units back to the spare area 504. As such, the number of the physical erasing units belonging to the spare area 504 returns to 2 (which is greater than the garbage collection threshold).

With reference to FIG. 22, afterwards, the memory control circuit unit 104 (or the memory management circuit 202) may select the physical erasing unit 410(1) from the spare area 504, use the first compression/decompression circuit 208 to compress the data UD13 and the data UD14 into compressed data UD13′ and data UD14′, issue a program command to write the data UD13′ and the data UD14′ into the 0^{th} and the 1^{st} physical programming unit of the physical erasing unit 410(1) and associate the physical erasing unit 410(1) to the data area 502. Therein, the physical programming units mapped to the 0^{th} and the first logical sub-unit of the logical unit LBA(2) (which are the second physical programming unit of the physical erasing unit 410(0) and the second physical programming unit of the physical erasing units 410(4)) are marked in the invalid data state.

According to the description with respect to FIG. 8 to FIG. 22, for the data corresponding to the write command from the host system 1000, the memory control circuit unit 104 (or the memory management circuit 202) may use the first compression/decompression circuit 208 for compression to complete the compression as soon as possible, so as to prevent the time for executing the write command from being delayed. Nevertheless, for the data being moved while the data merge operation is performed, the memory control circuit unit 104 (or the memory management circuit 202) may use the second compression/decompression circuit 210 for compression to achieve better compression efficiency.

It is to be mentioned that although in the example illustrated in FIG. 21, the memory control circuit unit 104 (or the memory management circuit 202) first uses the first compression/decompression circuit 208 to decompress the valid data (i.e., the data UD4′ and the UD6′) read from the physical erasing unit 410(1) and the valid data (i.e., the data UD7′) read from the physical erasing unit 410(2) back to the data UD4, the data UD6 and the data UD7 and then, re-uses the second compression/decompression circuit 210, but the invention is not limited thereto. For example, in another exemplary embodiment, the memory control circuit unit 104 (or the memory management circuit 202) may also directly use the second compression/decompression circuit 210 to compress the data UD4′ and the data UD6′ read from the physical erasing unit 410(1) and the data UD7′ read from the physical erasing unit 410(2) to generate the new compressed data UD4″, UD6″ and UD7″.

Additionally, in the exemplary embodiments, for the data corresponding to the write command from the host system 1000, the memory control circuit unit 104 (or the memory management circuit 202) first uses the first compression/decompression circuit 208 for compression and then, after the compressed data is temporarily stored in the buffer memory 212, issues the command sequence to write the compressed data into the rewritable non-volatile memory module 106. However, the present invention is not limited thereto, in another exemplary embodiment, the memory control circuit unit 104 (or the memory management circuit 202) may also directly issue the command sequence to transmit the data to be written to the rewritable non-volatile memory module 106 through the memory interface 206, and while the data is being transmitted to the rewritable non-volatile memory module 106, the first compression/decompression circuit 208 may compress the data being transmitted in an on the fly manner.

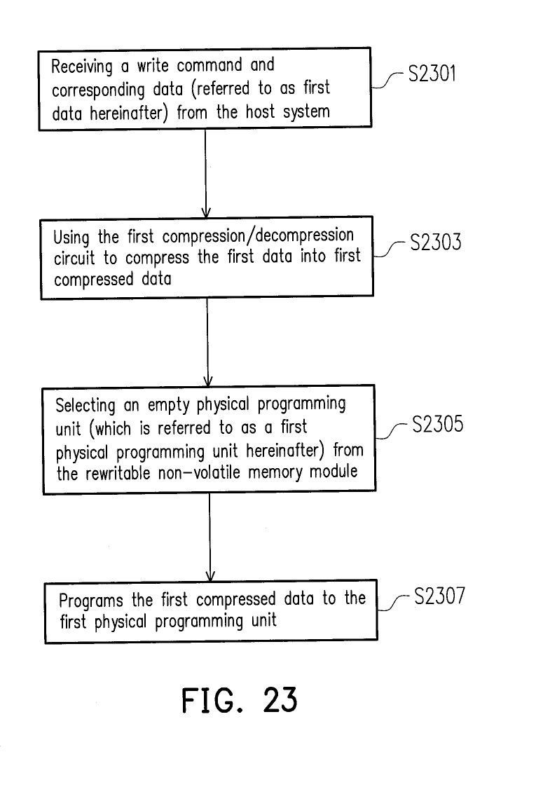

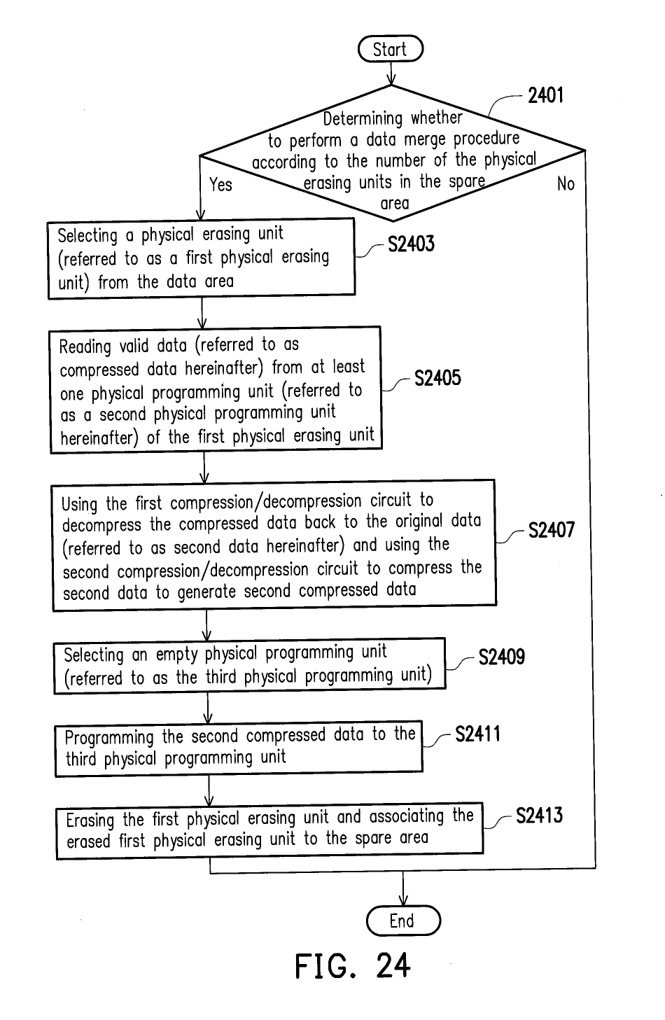

FIG. 23 and FIG. 24 are flowcharts illustrating the data writing method according to the first exemplary embodiment of the invention.

With reference to FIG. 23, in step S2301, the memory control circuit unit 104 (or the memory management circuit 202) receives a write command and corresponding data (referred to as first data hereinafter) from the host system 1000.

In step S2303, the memory control circuit unit 104 (or the memory management circuit 202) uses the first compression/decompression circuit 208 to compress the first data into first compressed data.

In step S2305, the memory control circuit unit 104 (or the memory management circuit 202) selects an empty physical programming unit (which is referred to as a first physical programming unit hereinafter) from the rewritable non-volatile memory module 106 and in step S2307, the memory control circuit unit 104 (or the memory management circuit 202) programs the first compressed data to the first physical programming unit.

With reference to FIG. 24, in step S2401, the memory control circuit unit 104 (or the memory management circuit 202) determines whether to perform a data merge procedure according to the number of the physical erasing units in the spare area 504.

If the data merge procedure is not needed, the process illustrated in FIG. 24 is terminated.

If the data merge procedure is needed, in step S2403, the memory control circuit unit 104 (or the memory management circuit 202) select a physical erasing unit (referred to as a first physical erasing unit) from the data area 502, and in step S2405, the memory control circuit unit 104 (or the memory management circuit 202) read valid data (referred to as compressed data hereinafter) from at least one physical programming unit (referred to as a second physical programming unit hereinafter) of the first physical erasing unit.

In step S2407, the memory control circuit unit 104 (or the memory management circuit 202) uses the first compression/decompression circuit 208 to decompress the compressed data back to the original data (referred to as second data hereinafter) and uses the second compression/decompression circuit 210 to compress the second data to generate second compressed data.

In step S2409, the memory control circuit unit 104 (or the memory management circuit 202) selects an empty physical programming unit (referred to as the third physical programming unit), and in step S2411, the memory control circuit unit 104 (or the memory management circuit 202) programs the second compressed data to the third physical programming unit.

Then, in step S2413, the memory control circuit unit 104 (or the memory management circuit 202) first erases the first physical erasing unit and associates the erased first physical erasing unit to the spare area 504.

### Second Exemplary Embodiment

The hardware structure of the memory storage apparatus in the second exemplary embodiment is substantially the same as that of the memory storage apparatus of the first exemplary embodiment, and the difference lies in that the memory storage apparatus of the first exemplary embodiment determines to use the first or the second compression/decompression circuit to perform the compression according to whether the data to be programmed is from the host system or the rewritable non-volatile memory, while the memory storage apparatus of the second exemplary embodiment determines to use the first or the second compression/decompression circuit to perform the compression according to whether each bit value of the data to be programmed belongs to a preset pattern. The operation of the memory storage apparatus of the second exemplary embodiment will be described in detail below with reference to the illustration of the memory storage apparatus of the first exemplary embodiment and using the reference numeral of each element thereof.

In the second exemplary embodiment, when being about to write data into the rewritable non-volatile memory 106, the memory control circuit unit 104 (or the memory management circuit 202) may determine whether each bit value of the data belongs to a preset pattern. For example, the preset pattern includes that each bit value is the same. However, it should be understood that the invention is not limited thereto. For example, in another exemplary embodiment, the memory control circuit unit 104 (or the memory management circuit 202) may record various types of data contents (e.g., “01010101 . . . ”, “10101010 . . . ” and so on) in a preset pattern table, and identify the data as belonging to the preset pattern when each bit value of the data to be written has a pattern same as one recorded in the preset pattern table.

If each bit value of the data belongs to the preset pattern (i.e., conforms to the first pattern), the memory control circuit unit 104 (or the memory management circuit 202) may use the first compression/decompression circuit 208 to compress the data and write the compressed data into the rewritable non-volatile memory. Additionally, if each bit value of the data does not belong to the preset pattern (i.e., the second pattern), the memory control circuit unit 104 (or the memory management circuit 202) may use the second compression/decompression circuit 210 to compress the data and write the compressed data into the rewritable non-volatile memory module 106.

It is to be mentioned that when the memory storage apparatus 100 receives a command from the host system 1000, the memory control circuit unit 104 (or the memory management circuit 202) must instantly execute the command and respond to the host system 1000 to avoid any delay. In this case, the mode where the procedure is executed in response to the host system 1000 is referred to as a foreground execution mode. By contrast, the memory control circuit unit 104 (or the memory management circuit 202) may perform an operation (e.g., data moving) in an idle state (i.e., with no command received from the host system 1000). In this case, the mode where the procedure is not executed in response to the host system 1000 is referred to as a background execution mode. Since the first compression/decompression circuit 208 has a higher processing speed and may satisfy the bandwidth of the host system 1000, the memory control circuit unit 104 (or the memory management circuit 202) may use the first compression/decompression circuit 208 to compress the data while instantly processing in response to the command from the host system 1000 (i.e., in the foreground execution mode). By contrast, since the second compression/decompression circuit 210 has a lower processing speed and is incapable of satisfying the bandwidth of the host system 1000, the memory control circuit unit 104 (or the memory management circuit 202) may use the second compression/decompression circuit 210 to compress data in the background execution mode. That is, when a selection of processing the command from the host system 1000 in the background execution mode is made, the memory control circuit unit 104 (or the memory management circuit 202) may temporarily store the command and data in the buffer memory 212 and respond to the host system 1000 that the command is executed and execute the command when memory storage apparatus 100 becomes idle (e.g., with no command received from the host system 1000 for a certain time period).

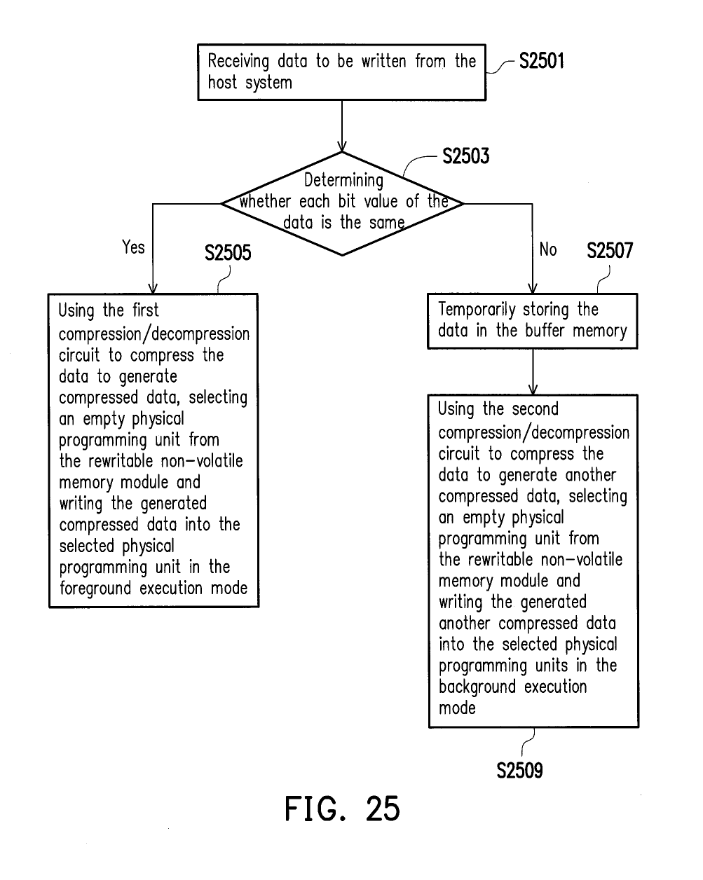

FIG. 25 is a flowchart illustrating a data writing method according to the second exemplary embodiment of the invention.

With reference to FIG. 25, in step S2501, the memory control circuit unit 104 (or the memory management circuit 202) receives data to be written from the host system 1000.

In step S2503, the memory control circuit unit 104 (or the memory management circuit 202) determines whether each bit value of the data is the same.

If each bit value of the data is the same, in step S2505, the memory control circuit unit 104 (or the memory management circuit 202) uses the first compression/decompression circuit 208 to compress the data to generate compressed data, selects an empty physical programming unit from the rewritable non-volatile memory module 106 and writes the generated compressed data into the selected physical programming unit in the foreground execution mode.

If each bit value of the data is not the same, in step S2507, the memory control circuit unit 104 (or the memory management circuit 202) temporarily stores the data in the buffer memory 212.

Then, in step S2509, the memory control circuit unit 104 (or the memory management circuit 202) uses the second compression/decompression circuit 210 to compress the data to generate another compressed data, selects an empty physical programming unit from the rewritable non-volatile memory module 106 and writes the generated another compressed data into the selected physical programming units in the background execution mode.

In light of the foregoing, the data writing method, the memory control circuit unit and the memory storage apparatus provided by the exemplary embodiments of the invention can select different compression/decompression circuits for compression according to the patters of the data to be written into the physical programming unit. Thereby, the data can be compressed by utilizing a compression mechanism having the higher compression speed when the processing speed is prioritized and can be compressed by utilizing a compression mechanism having the better compression efficiency when the time is sufficient, so as to meet demands for high compression speed and high compression rate. The previously described exemplary embodiments of the invention have the advantages aforementioned, wherein the advantages aforementioned not required in all versions of the invention.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A data writing method for a rewritable non-volatile memory module, wherein the rewritable non-volatile memory module comprises a plurality of physical erasing units, and each of the physical erasing units has a plurality of physical programming units, the data writing method comprising:
identifying whether data belongs to a first pattern or a second pattern;
if the data belongs to the first pattern, using a first compression/decompression circuit to compress the data to generate compressed data and writing the compressed data into the physical programming units; and
if the data belongs to the second pattern, using a second compression/decompression circuit to compress the data to generate another compressed data and writing the another compressed data into the physical programming units,
wherein a compression speed of the first compression/decompression circuit is higher than a compression speed of the second compression/decompression circuit, and a data compression rate of the first compression/decompression circuit is lower than a data compression rate of the second compression/decompression circuit.

2. The data writing method according to claim 1, wherein the step of identifying whether the data belongs to the first pattern or the second pattern comprises:
identifying first data instructed by a write command received from a host system as belonging to the first pattern; and
identifying second data read from the physical programming units as belonging to the second pattern.

3. The data writing method according to claim 2, wherein the step of using the first compression/decompression circuit to compress the data to generate the compressed data and writing the compressed data into the physical programming units comprises:
using the first compression/decompression circuit to compress the first data into first compressed data while transmitting the first data through a memory interface to the rewritable non-volatile memory module; and
writing the first compressed data into a first physical programming unit among the physical programming units.

4. The data writing method according to claim 3, further comprising:
performing a data merge operation to read one compressed data from a second physical programming unit among the physical programming units and using the first compression/decompression circuit to decompress the compressed data read from the second physical programming unit to obtain the second data,
wherein the step of using the second compression/decompression circuit to compress the data to generate the another compressed data and writing the another compressed data into the physical programming units comprises:
using the second compression/decompression circuit to compress the second data into second compressed data; and
writing the second compressed data into a third physical programming unit among the physical programming units.

5. The data writing method according to claim 3, further comprising:
performing a data merge operation to read the second data from a second physical programming unit among the physical programming units, wherein the second data is the data compressed by using the first compression/decompression circuit,
wherein the step of using the second compression/decompression circuit to compress the data to generate the another compressed data and writing the another compressed data into the physical programming units comprises:
using the second compression/decompression circuit to compress the second data into second compressed data; and
writing the second compressed data into a third physical programming unit among the physical programming units.

6. The data writing method according to claim 1, wherein the step of identifying whether the data belongs to the first pattern or the second pattern comprises:
determining whether each bit value of the data is the same;
if each bit value of the data is the same, identifying the data as belonging to the first pattern, wherein the step of using the first compression/decompression circuit to compress the data to generate the compressed data and writing the compressed data into the physical programming units is performed in a foreground execution mode; and
if each bit value of the data is not the same, identifying the data as belonging to the second pattern, wherein the step of using the second compression/decompression circuit to compress the data to generate the another compressed data and writing the another compressed data into the physical programming units is performed in a background execution mode.

7. A memory control circuit unit, configured to control a rewritable non-volatile memory, the memory control circuit unit comprising:
a host interface configured to be coupled to a host system;
a memory interface configured to be coupled to the rewritable non-volatile memory module, wherein the rewritable non-volatile memory module has a plurality of physical erasing units, and each of the physical erasing units has a plurality of physical programming units;
a memory management circuit coupled to the host interface and the memory interface;
a first compression/decompression circuit coupled to the memory management circuit; and
a second compression/decompression circuit coupled to the memory management circuit, wherein the memory management circuit identifies whether data belongs to a first pattern or a second pattern,
if the data belongs to the first pattern, the first compression/decompression circuit compresses the data to generate compressed data, and the memory management circuit issues a command sequence to write the compressed data into the physical programming units, and
if the data belongs to the second pattern, the second compression/decompression circuit compresses the data to generate another compressed data, and the memory management circuit issues a command sequence to write the another compressed data into the physical programming units,
wherein a compression speed of the first compression/decompression circuit is higher than a compression speed of the second compression/decompression circuit, and a data compression rate of the first compression/decompression circuit is lower than a data compression rate of the second compression/decompression circuit.

8. The memory control circuit unit according to claim 7, wherein in the operation of identifying whether the data belongs to the first pattern or the second pattern, the memory management circuit identifies first data instructed by a write command received from a host system as belonging to the first pattern and identifies second data read from the physical programming units as belonging to the second pattern.

9. The memory control circuit unit according to claim 8, wherein in the operation of compressing the data to generate the compressed data and writing the compressed data into the physical programming units,
the first compression/decompression circuit compresses the first data into first compressed data while the memory management circuit transmits the first data through the memory interface to the rewritable non-volatile memory module,
wherein the first compressed data is written into a first physical programming unit among the physical programming units.

10. The memory control circuit unit according to claim 9, wherein the memory management circuit performs a data merge operation to read one compressed data from a second physical programming unit among the physical programming units, and the first compression/decompression circuit decompresses the compressed data read from the second physical programming unit to obtain the second data,
wherein in the operation of compressing the data to generate the another compressed data and writing the another compressed data into the physical programming units, the second compression/decompression circuit compresses the second data into second compressed data, and the memory management circuit writes the second compressed data into a third physical programming unit of the physical programming units.

11. The memory control circuit unit according to claim 9, wherein the memory management circuit performs a data merge operation to read the second data from the second physical programming unit among the physical programming units, wherein the second data is compressed by the first compression/decompression circuit,
wherein in the operation of compressing the data to generate the another compressed data and writing the another compressed data into the physical programming units, the second compression/decompression circuit compresses the second data into second compressed data, and the memory management circuit writes the second compressed data into a third physical programming unit among the physical programming units.

12. The memory control circuit unit according to claim 7, wherein in the operation of identifying whether the data belongs to the first pattern or the second pattern, the memory management circuit determines whether each bit value of the data is the same,
if each bit value of the data is the same, the memory management circuit identifies the data as belonging to the first pattern, wherein the operation of the first compression/decompression circuit compressing the data to generate the compressed data and the memory management circuit writing the compressed data into the physical programming units is performed in a foreground execution mode; and
if each bit value of the data is not the same, the memory management circuit identifies the data as belonging to the second pattern, wherein the operation of the second compression/decompression circuit compressing the data to generate the another compressed data and the memory management circuit writing the another compressed data into the physical programming units is performed in a background execution mode.

13. A memory storage apparatus, comprising:
a connection interface unit configured to be coupled to a host system;
a rewritable non-volatile memory module having a plurality of physical erasing units, wherein each of the physical erasing units has a plurality of physical programming units; and
a memory control circuit unit coupled to the connection interface unit and the rewritable non-volatile memory module,
wherein the memory control circuit unit identifies whether data belongs to a first pattern or a second pattern,
if the data belongs to the first pattern, the memory control circuit unit uses a first compression/decompression circuit to compress the data to generate compressed data and writes the compressed data into the physical programming units,
if the data belongs to the second pattern, the memory control circuit unit uses a second compression/decompression circuit to compress the data to generate compressed another compressed data and writes the another compressed data into the physical programming units,
wherein a compression speed of the first compression/decompression circuit is higher than a compression speed of the second compression/decompression circuit, and a data compression rate of the first compression/decompression circuit is lower than a data compression rate of the second compression/decompression circuit.

14. The memory storage apparatus according to claim 13, wherein in the operation of identifying whether the data belongs to the first pattern or the second pattern, the memory control circuit unit identifies first data instructed by a write command received from a host system as belonging to the first pattern and identifies second data read from the physical programming units as belonging to the second pattern.

15. The memory storage apparatus according to claim 14, wherein in the operation of using the first compression/decompression circuit to compress the data to generate the compressed data and writing the compressed data into the physical programming units,
the memory control circuit unit uses the first compression/decompression circuit to compress the first data into first compressed data while transmitting the first data through a memory interface to the rewritable non-volatile memory module,
wherein the first compressed data is written into a first physical programming unit among the physical programming units.

16. The memory storage apparatus according to claim 14, wherein the memory control circuit unit performs a data merge operation to read one compressed data from a second physical programming unit among the physical programming units and uses the first compression/decompression circuit to decompress decompresses the compressed data read from the second physical programming unit to obtain the second data,
wherein in the operation of using the second compression/decompression circuit to compress the data to generate the another compressed data and writing the another compressed data into the physical programming units, the memory control circuit unit uses the second compression/decompression circuit to compress the second data into second compressed data and writes the second compressed data into a third physical programming unit among the physical programming units.

17. The memory storage apparatus according to claim 14, wherein the memory control circuit unit performs a data merge operation to read the second data from the second physical programming unit among the physical programming units, wherein the second data is compressed by the first compression/decompression circuit,
wherein in the operation of using the second compression/decompression circuit to compress the data to generate the another compressed data and writing the another compressed data into the physical programming units, the memory control circuit unit uses the second compression/decompression circuit to compress the second data into second compressed data and writes the second compressed data into a third physical programming unit among the physical programming units.

18. The memory storage apparatus according to claim 13, wherein in the operation of identifying whether the data belongs to the first pattern or the second pattern, the memory control circuit unit determines whether each bit value of the data is the same,
if each bit value of the data is the same, the memory control circuit unit identifies the data as belonging to the first pattern, wherein the operation of compressing the data to generate the compressed data and writing the compressed data into the physical programming units is performed in a foreground execution mode; and
if each bit value of the data is not the same, the memory control circuit unit identifies the data as belonging to the second pattern, wherein the operation of compressing the data to generate the another compressed data and writing the another compressed data into the physical programming units is performed in a background execution mode.
